(19) United States
(12) Patent Application Publication
(10) Pub. No.: US 2010/0043604 A1
(43) Pub. Date: Feb. 25, 2010

(54) RATCHET WRENCH HAVING EASILY ASSEMBLING STRUCTURE

(76) Inventor: Yi-Fu Chen, Taichung (TW)

Correspondence Address: Yi-Fu Chen, No.37-2, Ching-Dau Street, Taichung, 40464, omitted

(21) Appl. No.: 12/611,118

(22) Filed: Nov. 3, 2009

Related U.S. Application Data
(63) Continuation-in-part of application No. 12/002,432, filed on Dec. 18, 2007.

(51) Int. Cl. B25B 13/46

(52) U.S. Cl. 81/63.2

(57) ABSTRACT

The present invention discloses a ratchet wrench, which comprises a main body, a D-head, a threaded portion, a loose ratchet, a cardioid spring having extension leg and a closed tip, a rotatable disc having a shouldered hole with a first penetrating hole and a second penetrating hole connected by a connecting hole, and a ring. The rotatable disc is disposed on the head portion of the main body with the threaded portion of the D-head moving from the second penetrating hole and finally extending through the first penetrating hole, and a shift pin is defined at the bottom of the rotatable disc locating in the internal of the closed tip of the cardioid spring. The ring is disposed in the shouldered hole and threadedly engaged with the threaded portion so that the D-head rotatably positioned in the through bore of the main body.

### RELATED APPLICATION

This application is a Continuation-in-Part of U.S. application Ser. No. 12/002,432, entitled “RATCHET WRENCH”, naming Yi-Fu Chen as inventor, filed Dec. 18, 2007, and which is incorporated herein by reference.

### FIELD OF THE INVENTION

This invention relates to a ratchet wrench, and more particularly to a ratchet wrench having a rotatable disc can be laterally moved to provide the improvement of assembly.

### BACKGROUND OF THE INVENTION

A conventional ratchet wrench, as shown in FIG. 7, comprises: a main body 10 having a head portion 11 at one end, the head portion 11 having a through bore 12, and there being a plurality of teeth 13 formed in an inner wall surface thereof circumscribing the through bore 12; a D-head 20 rotatably disposed in the through bore 12, the D-head 20 having a plug joint portion 22 formed on a first end, a lateral side of the plug joint portion 22 provided a ball 70 thereon partially protruding outward; a threaded portion 21 with a first end connecting to a second end of the plug joint portion 22; a loose ratchet 30 disposed on a lateral side of the D-head 20, and the top of the loose ratchet 30 provided a hole 31 thereon; a cardioid spring 40 having opposite a first end and a second end, the first end defined at least an extension leg 41 therewith retained in the hole 31 of the loose ratchet 30, and the second end formed a closed tip 42 therewith; a rotatable disc 50 having a centrally disposed shouldered hole 52, the center of the bottom of the shouldered hole 52 provided a circular penetrating hole 53′ therethrough with a diameter matching the outer diameter of the threaded portion 21, the rotatable disc 50 being disposed on the head portion 11 of the main body 10 with the threaded portion 21 of the D-head 20 extending through the circular penetrating hole 53′ and a shift pin 51 defined at the bottom of the rotatable disc 50 locating in the closed tip 42 of the cardioid spring 40; and a ring 60 disposed in the shouldered hole 52 and threadedly engaged with the threaded portion 21 so that the D-head 20 rotatably positioned in the through bore 12 of the main body 10. However, the circular penetrating hole 53′ with a diameter matching with the threaded portion 21, the user not only should aim the circular penetrating hole 53′ of the rotatable disc 50 at the threaded portion 21, but also should aim the shift pin 51 of the rotatable disc 50 at the closed tip 42 of the cardioid spring 40 when assembly. Because the inner diameter of the closed tip 42 of the cardioid spring 40 is very small for only matching to accommodate the shift pin 51, so it is not easy and convenient for the user to assemble the rotatable disc 50 with the threaded portion 21 and the cardioid spring 40.

The mother application of this CIP application, U.S. application Ser. No. 12/002,432, entitled “RATCHET WRENCH”, naming Yi-Fu Chen as inventor, filed Dec. 18, 2007, as shown in FIG. 8, comprises: a main body 10 having a head portion 11 at one end, the head portion 11 having a through bore 12, and there being a plurality of teeth 13 formed in an inner wall surface thereof circumscribing the through bore 12; a D-head 20 rotatably disposed in the through bore 12, the D-head 20 having a plug joint portion 22 formed on a first end, a lateral side of the plug joint portion 22 provided a ball 70 thereon partially protruding outward; a threaded portion 21 with a first end connecting to a second end of the plug joint portion 22; a loose ratchet 30 disposed on a lateral side of the D-head 20, and the top of the loose ratchet 30 provided a hole 31 thereon; a cardioid spring 40 having opposite a first end and a second end, the first end defined at least an extension leg 41 therewith retained in the hole 31 of the loose ratchet 30, and the second end formed a closed tip 42 therewith; a rotatable disc 50 having a centrally disposed shouldered hole 52, the center of the bottom of the shouldered hole 52 provided a long groove 53″ therethrough, the rotatable disc 50 being disposed on the head portion 11 of the main body 10 with the threaded portion 21 of the D-head 20 extending through the long groove 53″ and a shift pin 51 defined at the bottom of the rotatable disc 50 locating in the internal of the closed tip 42 of the cardioid spring 40; and a ring 60 disposed in the shouldered hole 52 and threadedly engaged with the threaded portion 21 so that the D-head 20 rotatably positioned in the through bore 12 of the main body 10. However, the structures of some elements were not defined clearly, especially the structure of the long groove 53″ was not defined to comply with the enablement requirement.

### SUMMARY OF THE INVENTION

It is therefore a main object of the present invention to provide a ratchet wrench with rotatable disc which can be installed with the threaded portion and the cardioid spring rapidly and simply. The ratchet wrench comprises: a main body; a D-head; a threaded portion with a first end connecting to a second end of the plug joint portion; a loose ratchet disposed on a lateral side of the D-head, and the top of the loose ratchet provided a hole thereon; a cardioid spring having at least an extension leg retained in the hole of the loose ratchet and a closed tip; a rotatable disc having a centrally disposed shouldered hole, the center of the bottom of the shouldered hole provided a first penetrating hole, the first penetrating hole having a first circular arc with a diameter matching the outer diameter of the threaded portion to be a first receiving position for receiving the threaded portion, the rotatable disc disposed on the head portion of the main body with the threaded portion of the D-head extending through the first penetrating hole and a shift pin defined at the bottom of the rotatable disc locating in the closed tip of the cardioid spring; and a ring disposed in the shouldered hole and threadedly engaged with the threaded portion so that the D-head rotatably positioned in the through bore of the main body. The characterized structure of the present invention is: the bottom of the shouldered hole provided a second penetrating hole adjacent to the first penetrating hole, the second penetrating hole having a second circular arc opposite to the first circular arc of the first penetrating hole to be a second receiving position for receiving the threaded portion, the bottom of the shouldered hole provided a connecting hole to connect the first penetrating hole and the second penetrating hole so that the threaded portion can move between the first penetrating hole and the second penetrating hole via the connecting hole with respect to the rotatable disc when the rotatable disc moves laterally with respect to the center of the head portion.

### BRIEF DESCRIPTION OF THE DRAWINGS

FIG. 1 is a perspective view of the wrench in accordance with the present invention;

FIG. 2 is an enlarged view of the rotatable disc with partial cross section in accordance with the present invention;

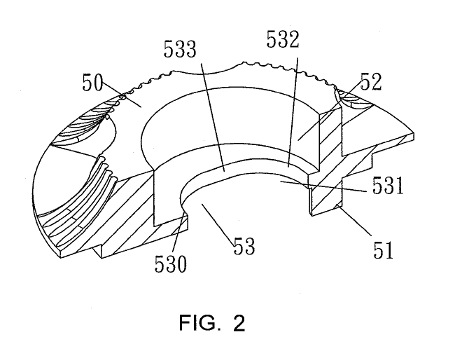

FIG. 3 is a perspective view of the uncompleted assembly of the wrench with the partial cross section of the rotatable disc in accordance with the present invention;

FIG. 4 is a top view of the uncompleted assembly of the wrench in accordance with the present invention;

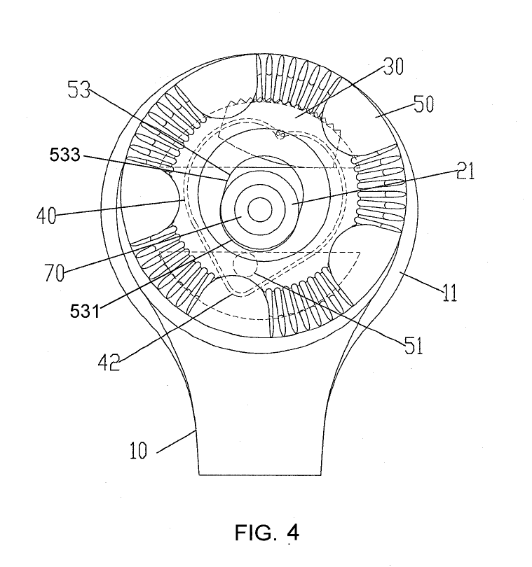

FIG. 5 is a perspective view of the completed assembly of the wrench with the partial cross section of the rotatable disc in accordance with the present invention;

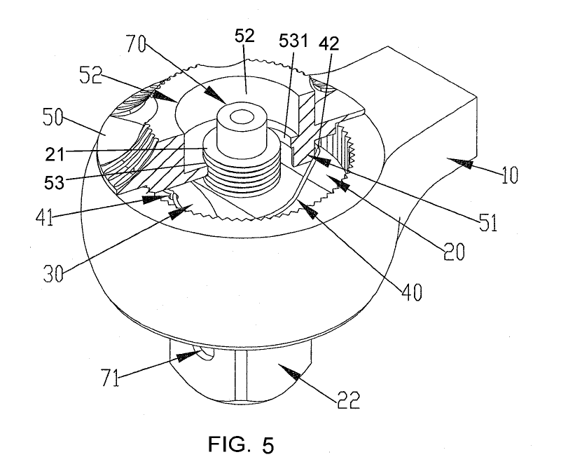

FIG. 6 is a perspective view of the completed assembly of the wrench in accordance with the present invention;

FIG. 7 is a perspective view of the wrench of one prior art; and

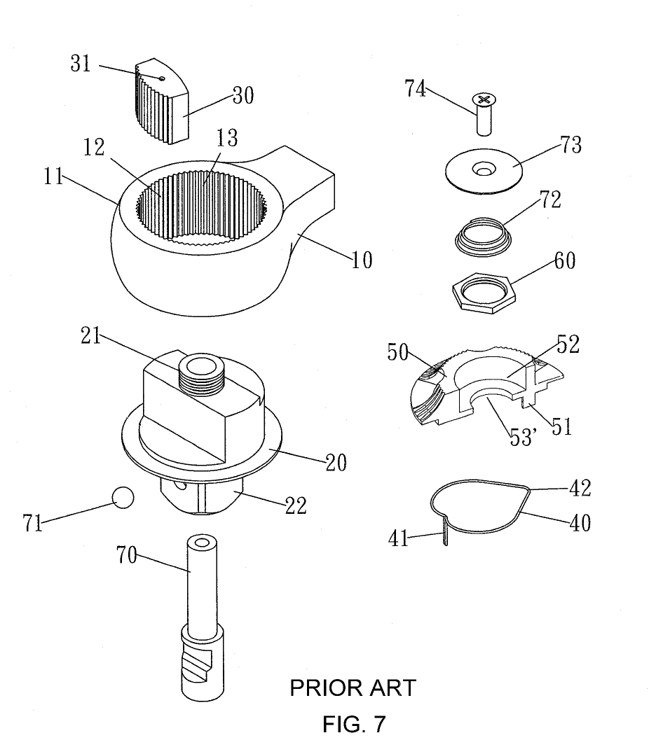

FIG. 8 is a perspective view of the wrench of the mother application of the present invention.

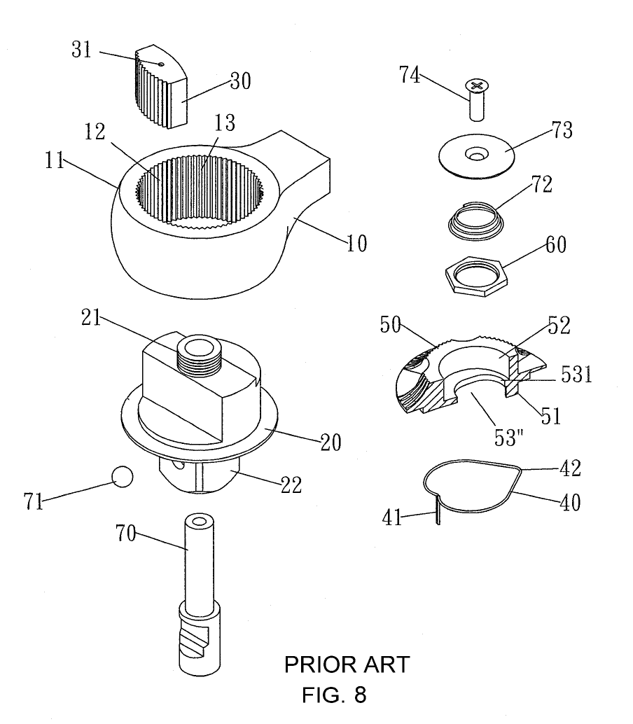

### DETAILED DESCRIPTION OF PREFERRED EMBODIMENTS

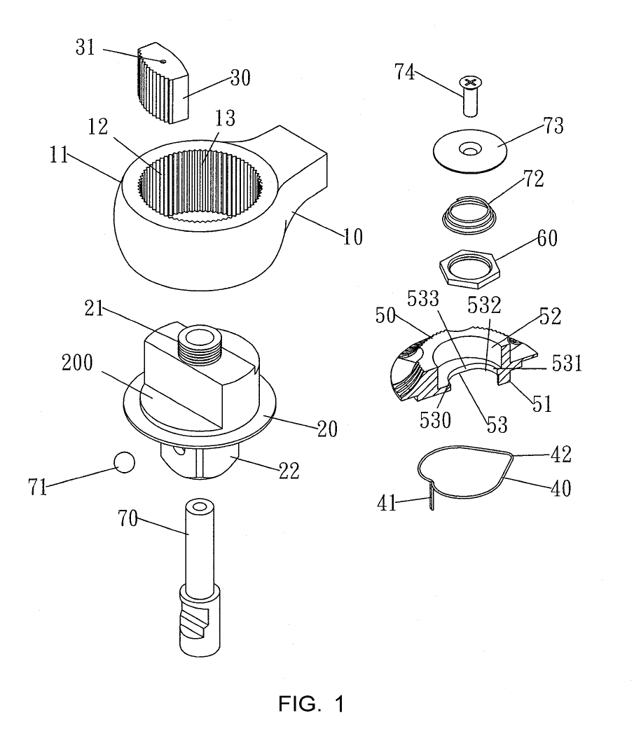

Referring to FIG. 1˜3, the ratchet wrench of the present invention basically comprising:

a main body 10, the main body 10 having a head portion 11 at one end, the head portion 11 having a through bore 12, and there being a plurality of teeth 13 formed in an inner wall surface thereof circumscribing the through bore 12;

a D-head 20 rotatably disposed in the through bore 12, the D-head 20 having a plug joint portion 22 formed on a first end (Referring to FIG. 1, the first end is the bottom of the D-head 20), a lateral side of the plug joint portion 22 provided a ball 70 thereon partially protruding outward;

a threaded portion 21 with a first end connecting to a second end of the plug joint portion 22 (Referring to FIG. 1, the second end is opposite to the first end of the D-head 20 and is the top of the D-head 20), and in one embodiment of the present invention, the threaded portion 21 being integrally formed with the D-head 20;

a loose ratchet 30 disposed on a lateral side of the D-head 20, in one embodiment of the present invention a cavity 200 being provided on the lateral side of the D-head 20 so that the loose ratchet 30 disposed in the cavity 200, and the top of the loose ratchet 30 provided a hole 31 thereon;

a cardioid spring 40 having opposite a first end and a second end, the first end defined at least an extension leg 41 therewith retained in the hole 31 of the loose ratchet 30, and the second end formed a closed tip 42 therewith;

a rotatable disc 50 having a centrally disposed shouldered hole 52, the center of the bottom of the shouldered hole 52 provided a first penetrating hole 53 therethrough, the first penetrating hole 53 having a first circular arc 530 with a diameter matching the outer diameter of the threaded portion 21 to be a first receiving position for receiving the threaded portion 21, the rotatable disc 50 being disposed on the head portion 11 of the main body 10 with the threaded portion 21 of the D-head 20 extending through the first penetrating hole 53 and a shift pin 51 defined at the bottom of the rotatable disc 50 locating in the closed tip 42 of the cardioid spring 40; and

a ring 60 disposed and limited in the shouldered hole 52 and connected with the top end of the threaded portion 21, in the illustrated embodiment, the ring 60 threadedly engaged with the threaded portion 21 so that the D-head 20 rotatably positioned in the through bore 12 of the main body 10;

the easily assembling structure of the ratchet wrench of the present invention, which characterized:

the bottom of the shouldered hole 52 provided a second penetrating hole 531 adjacent to the first penetrating hole 53, the second penetrating hole 531 having a second circular arc 532 opposite to the first circular arc 530 of the first penetrating hole 53 to be a second receiving position for receiving the threaded portion 21, the bottom of the shouldered hole 52 provided a connecting hole 533 to connect the first penetrating hole 53 and the second penetrating hole 531 so that the threaded portion 21 can move between the first penetrating hole 53 and the second penetrating hole 531 via the connecting hole 533 with respect to the rotatable disc 50 when the rotatable disc 50 moves laterally with respect to the head portion 11.

In one preferable embodiment of the present invention, wherein the width of two opposite sides of the connecting hole 533 is smaller than the diameter of the first circular arc 530 of the first penetrating hole 53. Because the width of two opposite sides of the connecting hole 533 is smaller than the diameter of the first circular arc 530 of the first penetrating hole 53, the sides of the connecting hole 533 can limit the threaded portion 21 in the first receiving position to avoid the rotatable disc 50 moving in unwilling condition. Wherein, the rotatable disc 50 generally is made by plastic material, in spite of the width of two opposite sides of the connecting hole 533 is smaller than the inner diameter of the first circular arc 530 and the outer diameter of the threaded portion 21, the threaded portion 21 can pass through the connecting hole 533 when the rotatable disc 50 is pushed by a small force of user.

In one prefer embodiment of the present invention, wherein the diameter of the first circular arc 530 and the second circular arc 532 is the same with each other, so that the first circular arc 530 and the second circular arc 532 are matching to the outer diameter of the threaded portion 21, and the threaded portion 21 can be exactly received in the first penetrating hole 53 at the first receiving position or in the second penetrating hole 531 at the second receiving position.

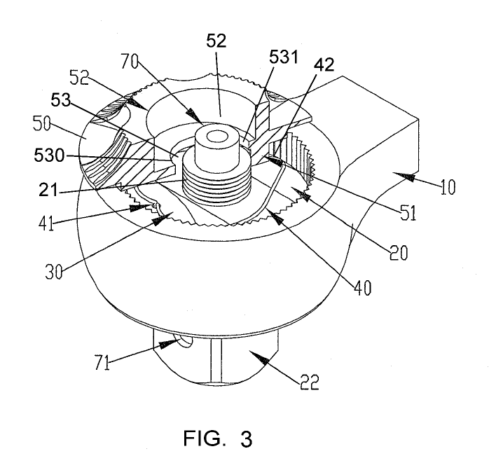

Referring to FIGS. 3˜5, for assembling the rotatable disc 50, the D-head 20 is rotatably disposed in the through bore 12 of the head portion 11 of the main body 10 firstly, then the loose ratchet 30 disposed in the cavity 200 to be disposed on the lateral side of the D-head 20 and accommodated in the through bore 12, and the cardioid spring 40 put on the top of the D-head 20 with the extension leg 41 retained in the hole 31 of the loose ratchet 30. Secondly, the rotatable disc 50 is laterally movably put on the top of the head portion 11 with the top end of the threaded portion 21 protruding through the second penetrating hole 531, and in the meanwhile the shift pin 51 points to the inner area of cardioid spring 40 with a bigger diameter than the closed tip end 42. Then, the ring 60 is threaded with the top end of the threaded portion 21 for holding the rotatable disc 50 and for avoiding the D-head 20 falling apart from the head portion 11. Finally, the rotatable disc 50 is laterally moved so that the threaded portion 21 is positioned in the first penetrating hole 53, the shift pin 51 is located in the internal of the closed tip 42 of the cardioid spring 40, and the bottom of the rotatable disc 50 is matched in the top portion of the through bore 12 of the head portion 11, and then the ring 60 is continuously rotated with respect to the threaded portion 21 until threaded completely and keep the rotatable disc 50 in a condition of being only rotatable but not movable.

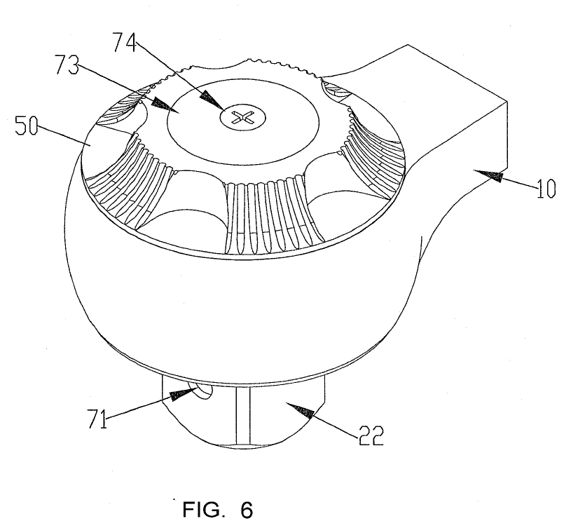

Referring to FIGS. 1 and 6, in one embodiment of the present invention, a push rod 70 is inserted in the D-head 20 and positioned by a screw 74 and a washer 73 for controlling the ball 70 lateral movement with respect to the D-head 20. Moreover, a spring 72 is mounted between the washer 73 and the ring 60, so that the push rod 70 has the ability to move back automatically when push down.

While we have shown and described the embodiment in accordance with the present invention, it should be clear to those skilled in the art that further embodiments may be made without departing from the scope of the present invention.

What is claimed is:

1. A ratchet wrench having easily assembling structure comprising:
a main body 10 having a head portion 11, the head portion 11 having a through bore 12 and a plurality of teeth 13 formed in an inner wall surface thereof circumscribing the through bore 12;
a D-head 20 rotatably disposed in the through bore 12 and having a plug joint portion 22 formed on a first end, a threaded portion 21 with a first end connecting to a second end of the plug joint portion 22, a lateral side of the plug joint portion 22 provided a ball 70 thereon partially protruding outward;
a loose ratchet 30 disposed on a lateral side of the D-head 20, and the top of the loose ratchet 30 provided a hole 31 thereon;
a cardioid spring 40 having opposite a first end and a second end, the first end of the cardioid spring 40 defined at least an extension leg 41 therewith retained in the hole 31 of the loose ratchet 30, the second end of the cardioid spring 40 formed a closed tip 42 therewith;
a rotatable disc 50 having a centrally disposed shouldered hole 52, the center of the bottom of the shouldered hole 52 provided a first penetrating hole 53 therethrough having a first circular arc 530 with a diameter matching with the outer diameter of the threaded portion 21 to be a first receiving position for receiving the threaded portion 21, the rotatable disc 50 being disposed on the head portion 11 of the main body 10 with the threaded portion 21 of the D-head 20 extending through the first penetrating hole 53 and a shift pin 51 defined at the bottom of the rotatable disc 50 locating in the closed tip 42 of the cardioid spring 40; and
a ring 60 disposed in the shouldered hole 52 and threadedly engaged with the threaded portion 21 so that the D-head 20 rotatably positioned in the through bore 12 of the main body 10;
wherein:
the bottom of the shouldered hole 52 provided a second penetrating hole 531 adjacent to the first penetrating hole 53, the second penetrating hole 531 having a second circular arc 532 opposite to the first circular arc 530 of the first penetrating hole 53 to be a second receiving position for receiving the threaded portion 21, the bottom of the shouldered hole 52 provided a connecting hole 533 to connect the first penetrating hole 53 and the second penetrating hole 531 so that the threaded portion 21 can move between the first penetrating hole 53 and the second penetrating hole 53 via the connecting hole 533 when the rotatable disc 50 moves laterally with respect to the head portion 11.

2. The ratchet wrench as claimed in claim 1, wherein the width of two opposite sides of the connecting hole 533 is smaller than the inner diameter of the first circular arc 530 of the first penetrating hole 53 and the outer diameter of the threaded portion 21.

3. The ratchet wrench as claimed in claim 1, wherein the diameter of the first circular arc 530 and the second circular arc 532 is the same with each other.
